(19) United States
(12) Patent Application Publication
(10) Pub. No.: US 2001/0032504 A1
(43) Pub. Date: Oct. 25, 2001

(54) Fuel level indicator for propane tank on a barbecue

(76) Inventor: C. William Moseley, Cambridge (CA)

Correspondence Address: DARYL W SCHNURR, BARRISTER & SOLICITOR, PO BOX 2607, 18 WEBER STREEST WEST, KITCHENER, ONTARIO, N2H 6N2, CA

(21) Appl. No.: 09/794,495

(22) Filed: Feb. 28, 2001

Related U.S. Application Data
(60) Provisional application No. 60/187,404, filed on Mar. 7, 2000.

(51) Int. Cl. G01F 23/00

(52) U.S. Cl. 73/290 R; 340/613

(57) ABSTRACT

A fuel level indicator for a propane tank has a top and a base. The top has means to receive and support a propane tank. The top is spring mounted to a base by bolts surrounded by springs. The top moves downward when a full propane tank is mounted thereon. As the tank empties, the top moves upward from the force of the springs. A level indicator is located on the device to indicate the level of the top above the base. In a further embodiment a remote fuel level indicator is used.

### BACKGROUND OF THE INVENTION

1. Field of Invention

This invention relates to a fuel level indicator for a propane tank located on a barbecue.

2. Description of the Prior Art

Gas fired barbecues, most using propane as a fuel source, have a tank containing gas under pressure. In barbecues used for domestic purposes, the fuel supply in propane tanks lasts for many months and, depending on usage, can even last for one or more years. The tanks do not have a fuel level indicator and when a tank becomes empty, there is no prior warning. In almost all cases, the food being barbecued will not be fully cooked when the gas supply runs out. For this reason, many consumers keep a spare tank on hand. However, tools are required to remove the empty tank and replace it and, depending on how well organized the consumer is, that process could take 5 minutes or it could take 30 minutes or even more time. In the meantime, the food that was being barbecued will have cooled off and other parts of the meal that are being prepared on something other than the barbecue might well be overcooked.

The problem of not having a fuel level indicator has existed for some time and, while there are other ways of detecting the fuel level in a tank containing gas under pressure, it is desirable to have an indicator that does not require any tools to install or remove and does not require any adjustment to be made by the user of the barbecue once a full tank has been installed until it is desirable to remove that tank.

### SUMMARY OF THE INVENTION

It is an object of the present invention to provide a fuel level indicator for a propane tank mounted on a barbecue where the indicator can be installed or removed without tools and no adjustments or changes to the operation of the barbecue are required from the time that a full tank is installed on the barbecue until a nearly empty tank is removed.

A fuel level indicator for use with a barbecue and a tank containing gas under pressure, said top having a substantially centrally located circular opening therein to receive the tank. The top is large enough to extend beyond the tank. The fuel level indicator has at least three support posts extending between the top and the base. Each support post has a spring thereon located between the top and the base. The springs are sized to have sufficient force so that when a full tank is placed on the top, the top will slide downward along the bolts while compressing the springs so that the top and base are very close to one another. The springs are sized so that as the tank empties, the springs extend until the tank is nearly completely empty when the springs have extended to such an extent that the top has almost returned to its original position before the tank was installed.

Preferably, there is a scale located on the indicator to display whether the tank is nearly full or nearly empty or at some point in between.

A propane tank, barbecue and fuel level indicator in combination.

### BRIEF DESCRIPTION OF THE DRAWINGS

FIG. 1 is a perspective view of the fuel level indicator of the present invention;

FIG. 2 is a side view of a propane tank on the fuel level indicator where the tank is nearly full;

FIG. 3 is a side view of a tank on the indicator where the tank is nearly empty;

FIG. 4 is a front view of a tank on the fuel level indicator;

FIG. 5 is a front view of a barbecue, fuel level indicator and tank where the fuel level indicator has a remote indicator accessory;

FIG. 6 is a side view of a fuel level indicator, tank and barbecue in combination where the fuel level; and has a remote indicator.

FIG. 7 is a side view of a fuel level indicator made out of plastic material.

### DESCRIPTION OF A PREFERRED EMBODIMENT

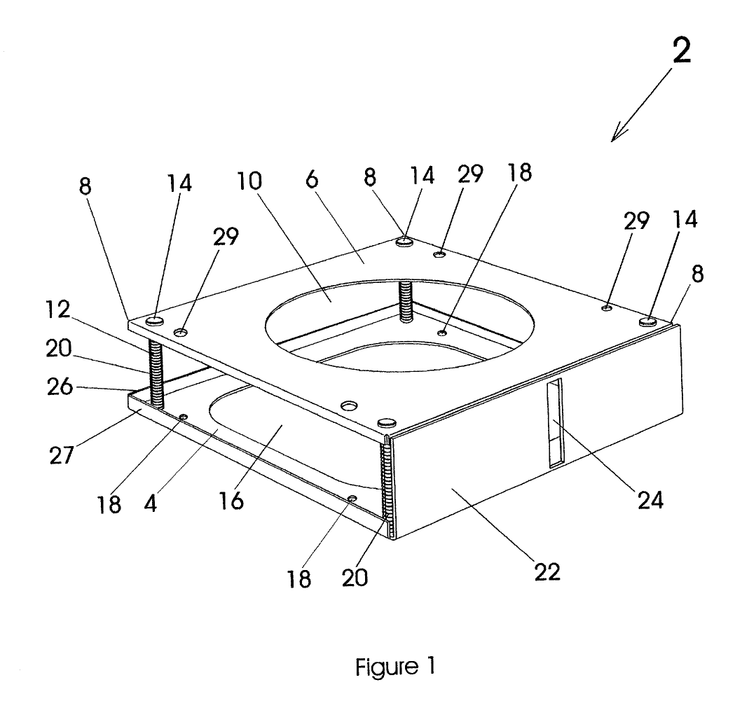

In FIG. 1, a fuel level indicator 2 has a base 4 and top 6. The top 6 has a generally square shape with four comers 8. An opening 10 that is preferably centrally located in the top 6 is sized to receive a base of a propane tank (not shown in FIG. 1). At each of the four comers 8, there is located a bolt 12 having a head 14. Each of the bolts 12 extends through a hole (not shown in FIG. 1) that is large enough to readily receive the bolt yet small enough so that the head 14 of each bolt will not pass through the hole. The holes (not shown in FIG. 1) are large enough so that the top can slide upward and downward along each of the bolts. The bolts 12 are anchored in the base which conforms generally with the shape of the top 6. The base 4 has a central portion 16 that is cut away and has mounting holes 18 for mounting the base onto a barbecue (not shown in FIG. 1). Surrounding each of the bolts 12 are springs 20 that are substantially identical to one another. The springs 20 extend between the base 4 and the top 6. When there is no tank resting on the top 6, the springs are in a fully extended position with the top 6 resting against the heads 14. While springs with other specifications could be used, it has been found that four springs that each have a primary load specification of six pounds at 2.5 inches and a secondary load of 10.5 pounds at 1.0 inches are suitable for the purposes of the present invention. The base 4 has a front face 22 thereon containing an elongated opening 24. The elongated opening 24 has a scale thereon to indicate full (“F”) and empty (“E”) at the bottom and top respectively thereof. Preferably, there is an upturned flange 26 along a rear and upturned flanges 27 along each side of the base 4 to provide additional strength to the base 4. The holes 29 are located in vertical alignment with the holes 18 to allow a screwdriver to be inserted through the holes 29 in order to turn screws into the barbecue (not shown) through the holes 18.

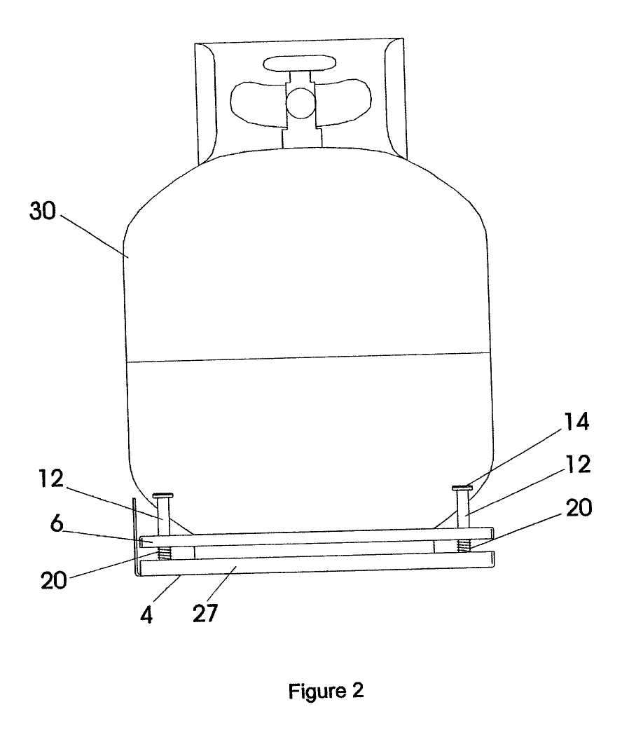

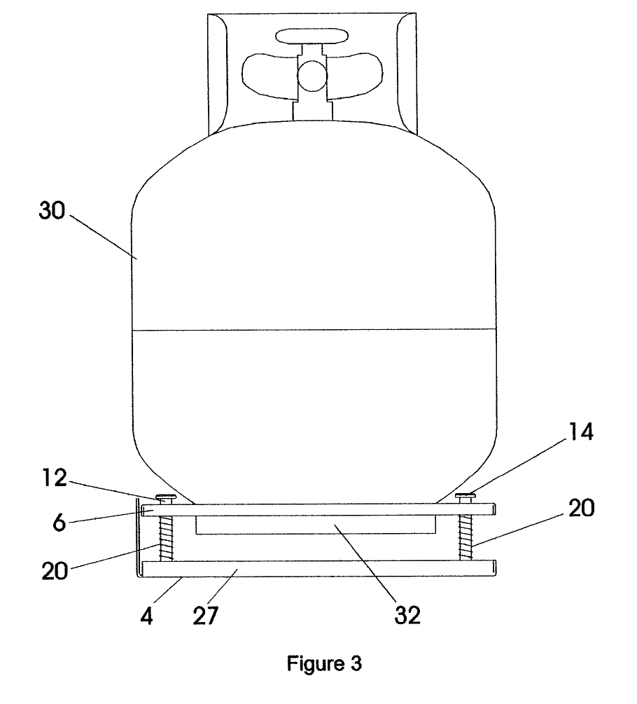

In FIGS. 2, 3 and 4, the same reference numerals are used to describe those components that are identical to those components of FIG. 1 without further description unless indicated. In FIG. 2, a propane tank 30 that is almost full of propane (not shown) is mounted on the fuel level indicator 2. It can be seen that a base 32 of the tank 30 extends through the top 6 so that the remainder of the tank 30 rests on said top. It can be seen that the weight of the tank compresses the springs 20 so that the top 6 slides down the bolts 12 and the base 32 of the tank 30 is almost touching the base 4 of the fuel level indicator 2. In FIG. 3, the same reference numerals are used to describe those components that are shown in FIG. 2 without further description unless otherwise indicated. The tank 30 is nearly empty and it can be seen that the top 6 is at a much higher level than the top 6 of FIG. 2. In FIG. 3, the top 6 is almost in contact with the heads 14 of the bolts 12.

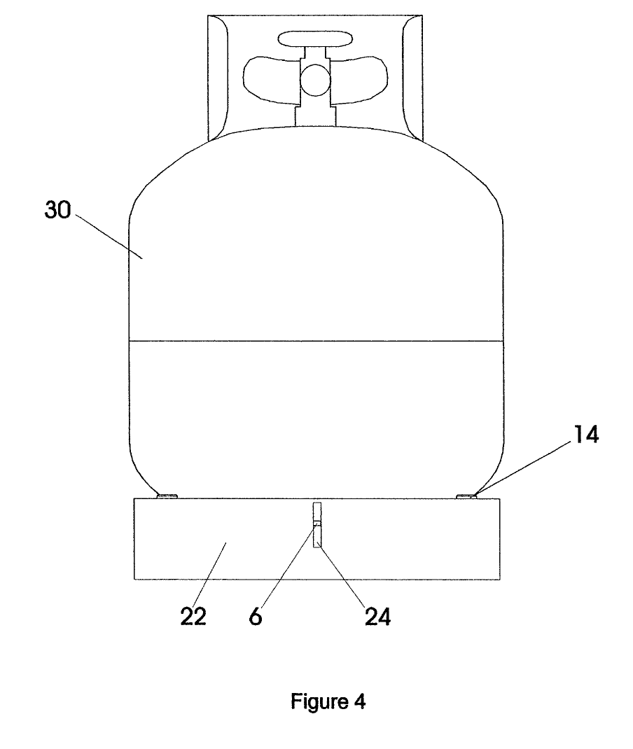

In FIG. 4, the same reference numerals are used to describe those components that are identical to those in FIGS. 2 and 3 without further description unless otherwise indicated. In FIG. 4, it can be seen that the top 6 provides an indicator in the elongated opening 24 to show that the tank 30 is part way between full and empty. A pointer could be mounted to the top 6 to extend into the elongated opening 24 where the pointer would function as an indicator.

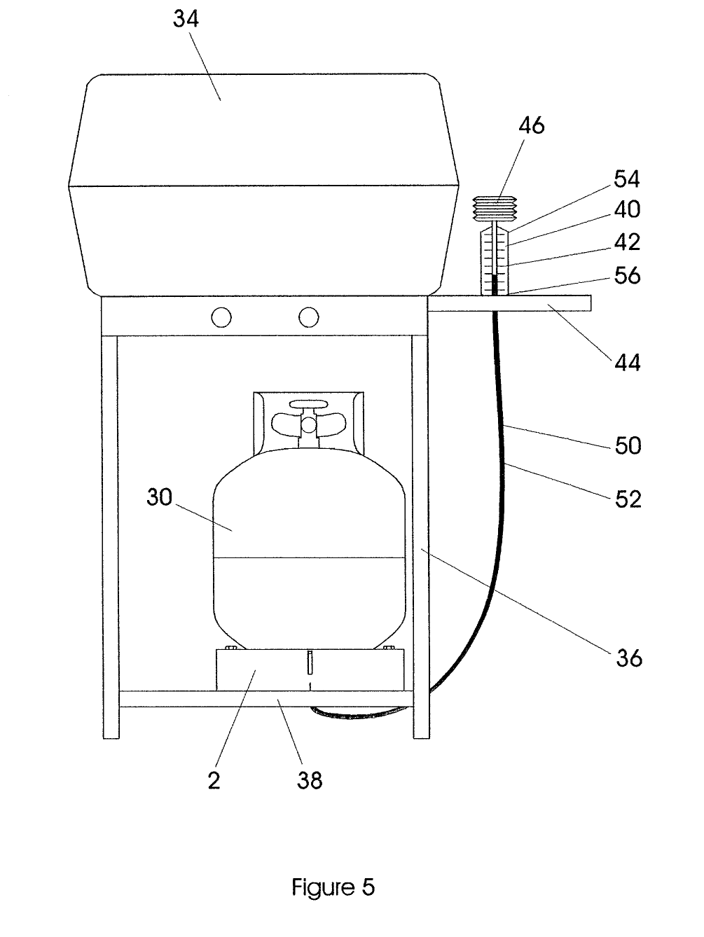

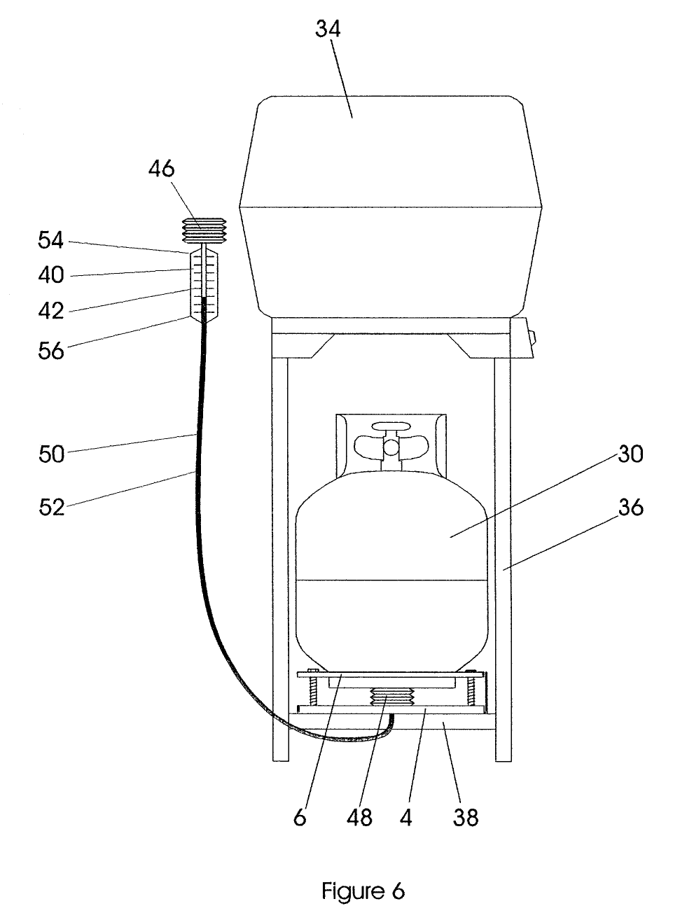

In FIGS. 5 and 6, the same reference numerals are used as those used in FIGS. 1 to 4 to describe those components that are identical without further description. It can be seen that a conventional gas barbecue 34 has a frame 36 with a lower shelf 38. The fuel level indicator 2 is preferably attached to the lower shelf 38 by screws through the mounting holes 18 (not shown in FIGS. 5 and 6). The amount of fuel remaining in the tank 30 can be determined using the scale on the elongated opening 24. However, the barbecue 34 has an added feature of a remote level indicator 40. The remote level indicator 40 is optional and provides a second scale 42 on an upper portion of the barbecue where it can be more easily read by an operator. While the scale 42 is shown to be resting in midair in FIG. 6, it could be affixed to an upper shelf 44 or it could be otherwise affixed to an upper part of the frame 36. The remote level indicator 40 has an upper bellows 46 and a lower bellows 48. The lower bellows 48 is located beneath the propane tank 30 and is preferably centrally located between the tank 30 and the base 4. A tube 50 extends from the lower bellows 48 through the second scale 42 to the upper bellows 46. The lower bellows 48 and the tube 50 up to part of the second scale 42 are filled with colored liquid 52. The remaining part of the tube in the upper bellows contain air. The bellows 46, 48 and tube 50 constitute a closed system. When a full propane tank is placed on the top 6 of the fuel level indicator 2 the top 6 will be forced downward toward the base 4 thereby compressing the lower bellows 48. The compression of the lower bellows 48 will cause a colored liquid to flow toward the upper bellows 46 and the liquid will then move to a point near a top 54 of the second scale 42. As the tank 30 empties the top 6 of the fuel indicator will move upward and the lower bellows 48 will expand thereby dropping the level of the liquid 54 on the second scale 42. Ultimately, when the tank 30 is nearly empty, the liquid on the scale will be at the nearly empty indicator at a bottom 56 of the second scale 42. The purpose of the upper bellows 46 is to receive the air that is forced out of the tube 50.

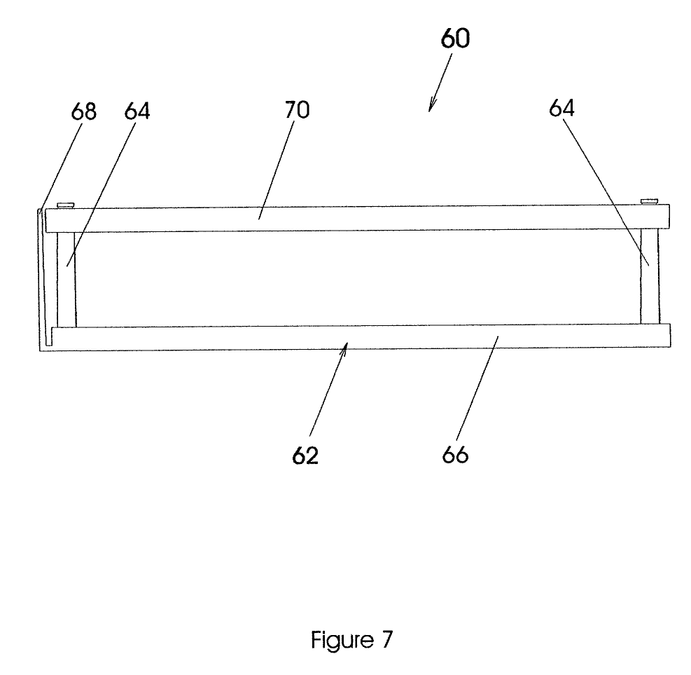

In FIG. 7, there is shown a side view of a fuel level indicator 60, which is made out of plastic. A base 62 is molded with the posts 64, lip 66 and font panel 68 in one piece. A top 70, also made out of plastic, is a separate piece, which is placed on the posts 64 (only two of which are shown) and held in place by retainers (not shown) that fit into a groove (not shown) on each post. The springs on each post 64 have been omitted from FIG. 7.

An advantage of the fuel indicator of the present invention is that after the fuel indicator is installed on the barbecue, no tools are required to install or remove the tank from the fuel indicator. Of course, tools will be required to connect the tank to the gas supply line of the barbecue in the same conventional manner as tanks are presently connected. Further, when a tank has been installed on the fuel indicator 2, the barbecue is operated in exactly the same way as existing barbecues are operated. Since most of these barbecues are portable, they are moved from place to place. Many of the barbecues have wheels at one end of the frame so that barbecues can be moved into a garage or other storage area when they are not being used. Further, the fuel indicator of the present invention is not connected in any way to the gas supply from the tank and the use of the tank is as safe with the indicator 2 of the present invention or with the remote indicator 40 as it would be with a conventional barbecue and propane tank with no indicator.

While the tank is described as a propane tank, other fuels under pressure within a tank can also be used with the indicator of the present invention. Also, the fuel indicator is not required to be installed or located on the barbecue. The fuel indicator could be located on the ground beside the barbecue with the propane tank located on top of the fuel indicator and connected to the barbecue.

I claim:

1. A fuel level indicator for use with a barbecue and a tank containing gas under pressure, said fuel level indicator having a base and a top, said top having a substantially centrally located circular opening therein to receive said tank, said top being large enough to extend beyond said tank, said fuel level indicator having at least three support posts extending between said top and said base, each support post having a spring thereon located between said top and said base said springs being sized to have sufficient force so that when a full tank is placed on said top, said springs will be compressed and said top will be close to said base, said springs being sized so that as the tank empties, said springs extend until the tank is nearly completely empty when said springs have extended so that said top has returned almost to its original position before said tank was installed.

2. A fuel level indicator as claimed in claim 1 wherein there is a scale located on said indicator to display a degree of fullness of said tank.

3. A fuel level indicator wherein said indicator has a generally square shape with four corners and there is one post of said at least three posts at each corner.

4. A fuel level indicator as claimed in claim 1 wherein said posts are bolts.

5. A fuel level indicator as claimed in claim 1 wherein said base is made from plastic material and said posts are molded on said base.

6. A fuel level indicator as claimed in claim 1 wherein said fuel indicator is mounted on said barbecue.

7. A fuel level indicator as claimed in claim 2 wherein the said scale is located on said barbecue at a remote location from said fuel level indicator, but connected to said fuel level indicator by tubing.

8. A fuel level indicator as claimed in claim 7 wherein there is a lower bellows connected to said tubing beneath said tank and an upper bellows connected to said tubing at said remote level indicator.
